(19) United States
(12) Patent Application Publication
(10) Pub. No.: US 2018/0322555 A1
(43) Pub. Date: Nov. 8, 2018

(54) A DESIGN SYSTEM AND METHOD

(71) Applicant: The Stainless Steel Monument Company Pty Ltd, Coogee (AU)

(72) Inventors: Albert William De Boer, Coogee (AU); Robert Szymanski, Coogee (AU)

(21) Appl. No.: 15/773,294

(22) PCT Filed: Nov. 2, 2016
(86) PCT No.: PCT/AU2016/051040

§ 371 Date: May 3, 2018

(30) Foreign Application Priority Data
Nov. 3, 2015 (AU) 2015904496

(51) Int. Cl. G06Q 30/06; G06F 3/0485

(52) U.S. Cl. CPC G06Q 30/0621; G06Q 50/01; G06F 3/0485; G06Q 30/0643

(57) ABSTRACT

Provided is a computer-implemented method (400) for product design, the method (400) generally comprising a first step (402) of providing a graphical user interface (GUI) to a user for inputting product specifications, said GUI including a plurality of design modules each providing specific product specification customisation options. Once the GUI has been provided (402), a user is able to provide product specifications, which is then received (404) by the system (300). The method (400) then provides a substantially real-time user-manipulable visualisation of the specified product via the GUI. In addition, the GUI generally further also includes a pricing engine configured to provide substantially real-time product pricing information (410) according to the selected product specifications. Once the product has been finalised, in response to receiving a final product approbation via the GUI (indicated by block 412), the method (400) includes the step of automatically sequencing the product specifications required for manufacturing the final product. In addition, the method further includes the step (418) of outputting such manufacturing sequence in a predetermined format.

### TECHNICAL FIELD

The present invention generally relates to product design, and more particularly to a computer-implemented method and associated system for product design.

### COPYRIGHT NOTICE/PERMISSION

A portion of the disclosure of this patent specification contains material that is subject to copyright protection. The copyright owner has no objection to the reproduction by anyone of the patent specification or parts thereof as it appears in the file or records of a Patent Office, but otherwise reserves all copyrights whatsoever.

The following discussion of the background art is intended to facilitate an understanding of the present invention only. The discussion is not an acknowledgement or admission that any of the material referred to is or was part of the common general knowledge as at the priority date of the application.

### BACKGROUND

In general terms, in a networked information or data communications system, a user has access to one or more terminals which are capable of requesting and/or receiving information or data from local or remote information sources. In such a communications system, a terminal may be a type of processing system, computer or computerised device, personal computer (PC), mobile, cellular or satellite telephone, mobile data terminal, portable computer, Personal Digital Assistant (PDA), pager, thin client, or any other similar type of digital electronic device. The capability of such a terminal to request and/or receive information or data can be provided by software, hardware and/or firmware. A terminal may include or be associated, both locally and remote, with other devices, for example a local data storage device such as a hard disk drive or solid state drive, a networked remote data storage device, or the like.

An information source can include a server, or any type of terminal, that may be associated with one or more storage devices that are able to store information or data, for example in one or more databases residing on a storage device. The exchange of information (i.e., the request and/or receipt of information or data) between a terminal and an information source, or other terminal(s), is facilitated by a communication means. The communication means can be realised by physical cables, for example a metallic cable such as a telephone line, semi-conducting cables, electromagnetic signals, for example radio-frequency signals or infra-red signals, optical fibre cables, satellite links or any other such medium or combination thereof connected to a network infrastructure.

The network infrastructure can include devices such as a telephone switch, base station, bridge, router, or any other such specialised network component, which facilitates the connection between a terminal and an information source. Collectively, an interconnected group of terminals, communication means, infrastructure and information sources is referred to as a network. The network itself may take a variety of forms. For example, it may be a computer network, telecommunications network, data communications network, Local Area Network (LAN), Wide Area Network (WAN), wireless network, Internetwork, Intranetwork, the Internet and developments thereof, transient or temporary networks, combinations of the above or any other type of network providing for communication between computerised, electronic or digital devices. More than one distinct network can be provided, for example a private and a public network. A network as referenced in this specification should be taken to include any type of terminal or other similar type of electronic device, or part thereof, which is rendered such that it is capable of communicating with at least one other terminal.

In addition, the Hyper-Text Mark-Up Language (HTML) and Hyper-Text Transfer Protocol (HTTP), and developments thereof, have made the Internet or World Wide Web (WWW) very accessible. The exchange of information on the Internet is further facilitated through hyper-text documents. Hyper-Text documents are unique in that they use tags to define links which, when selected, retrieve the related information from within the same document or from a new document altogether. The links are defined using HTML which provides a document formatting method which adapts in a consistent manner to any computer on which it is displayed. HTML tags are used to define various components of text, visual or audio which make up a hyper-text document, including such things as formatting and linking to other documents. HTML tags which link documents on one Internet information source to those on another do so by associating a Uniform Resource Locator (URL) with the referenced information. An example of an HTML development would include Extensible Mark-up Language (XML), which is a mark-up language that defines a set of rules for encoding documents in a format which is both human-readable and machine-readable.

One appeal of the Internet is the large-scale interconnection of public and private networks. A proxy is a host computer or mechanism (usually an application program) on a network node or terminal which performs specialised functions on a network. One such function is to provide network security. Security is provided between a private and public network by requiring communications (i.e. information or data exchanges) to pass through the proxy. Another function of a proxy is to store or cache recently accessed information, for example copies of documents and images. If a web browser desires information which is located outside the local network, that is to say on an information source attached to an external network, communications pass from the web browser through the proxy before entering the external network. Thus, a proxy may operate to deny access to a private network from a public network by not replying to HTTP commands received from the public network.

In light of the above, considering now more an objective of the present invention, online design or customisation of products is known. These products typically include customised products that can be obtained through web-based purchasing systems. However, such so-called online Design-Your-Own (DYO) systems as they exist today are generally rudimentary in their capabilities. Most of these DYO platforms are structured more like a fixed template-based design system with limited design options. In this scenario, a user can typically choose a product and then specify one or two options, such as for example a colour, a size, or the like.

The current use of these DYO systems is to provide limited customised products directly to the consumer in the comfort of their own home. The Applicants have identified a shortcoming with conventional DYO systems in that they do not offer users access to a range of customisable products whilst providing the users the ability to personally design each of these products to their specifications in a manner that is user-friendly and simple to do.

There is a need for a system and associated method which addresses or at least partly ameliorates one or more shortcomings inherent in the prior art.

### BRIEF SUMMARY

According to a first aspect of the invention there is provided a computer-implemented method for product design, said method comprising the steps of:

providing a graphical user interface (GUI) to a user for inputting or selecting product specifications, said GUI including a plurality of design modules each providing specific product specification customisation options, said GUI further having a pricing engine configured to provide substantially real-time product pricing information according to the selected product specifications;

in response to receiving such product specifications, providing a substantially real-time user-manipulable visualisation of the specified product via the GUI;

in response to receiving a final product approbation via the GUI, automatically sequencing the product specifications required for manufacturing the final product; and

outputting such manufacturing sequence in a predetermined format.

The step of providing the GUI may include providing an online accessible environment or portal which, when accessed by a user, provides the GUI on a terminal of the user.

The step of providing the GUI may include providing a set of instructions that, when executed on a terminal, provides the GUI with design modules and pricing engine. Typically, such a set of instructions are adapted to update the GUI, design modules and/or pricing engine via a network.

The product may be selected from a group consisting of a memorial product, an architectural product, a consumer product and an automotive product.

Accordingly, the memorial product may be selected from a group consisting of a headstone, a tombstone, a plaque, an urn and a monument. The architectural product may be selected from a group consisting of doors, windows, gates, fences, security screens, ornamentations, kitchen splashbacks, water features, garden features and ornaments, bathroom fixtures and fittings, and light fixtures and fittings.

Similarly, the consumer product may be selected from a group consisting of furniture, pet products, toys, trophies, computers, telephones, mobile phones, handbags, clothing and clothing accessories, sporting equipment, watches, footwear, jewellery and memorabilia, signage, business cards, food items, meals having a specific calorific content and make-up, and decorative cards. The automotive product may be selected from a group consisting of cars, motorcycles, boats and aeroplanes.

The product specifications may be selected from a group consisting of product type, product cost, product size, product volume, product surface area, product material, product decoration type, product decoration style, product manufacturing method, and product colour.

Accordingly, each design module may be configured for providing specific product specification customisation options for each of the available product specifications. Typically, a design module may comprise a database of different options for a specific product specification, e.g. where the product specification is colour, the customisation options may include blue, red, green, yellow, orange, black, white, etc.

The pricing engine may be configured to provide substantially real-time product pricing information by comprising a pricing algorithm adapted to calculate product pricing dependent on specified product type, product cost, product size, product volume, product surface area, product material, product decoration type, product decoration style, product manufacturing method, and/or product colour.

The pricing engine may be configured to provide product pricing information whenever the user selects and/or changes the product specifications.

It is to be appreciated that reference to ‘substantially real-time’ within this specification is to be understood as meaning an instance of time that may include a delay typically resulting from processing, calculation and/or transmission times inherent in processing systems or web-based transmissions. For example, the pricing engine is typically configured to provide pricing information whenever the product specifications change. Such changes require time to transmit from the GUI to the pricing engine, which then calculates the updated pricing information, and then transmits it back to the GUI. These transmission and calculations times, albeit of generally small duration, do introduce some delay, i.e. typically less than a minute or within milliseconds, but the user is provided with relevant feedback information relatively quickly or within ‘substantially real-time’.

The user-manipulable visualisation may include a two-dimensional and/or three-dimensional virtual rendition or representation of the product and/or product specifications with which the user is able to interact on the GUI. Such interactions may include panning, rotating or zooming the representation of the product and/or product specifications.

The step of receiving final product approbation may include receiving an indication from the user that no more product specifications will be selected and/or customised.

The step of automatically sequencing the product specifications may include determining an order in which the selected product specifications are to be manufactured and/or applied to the product. It is to be appreciated that the step of sequencing involves a manner of ‘intelligent’ decision-making by a computer system performing the method, as the manufacturing of a product depends on the selected product specifications, the type of product, availability of manufacturing capacity, etc.

As such, the step of outputting the manufacturing sequence may include providing an indication of the selected product specifications and the order in which they are to be manufactured and/or applied to the product.

The predetermined format may include a manufacturing machine-interpretable format, such as a vector file format, an Encapsulated PostScript (EPS) file format, a graphical file format (JPG, JPEG, BMP, GIF, etc.), or the like.

The method may include a step of associating the final product specifications with the user. Such step of associating may include registering a user profile on a database and linking the final product specification with such user profile.

The method may include the step of transmitting the manufacturing sequence to at least one manufacturing facility.

The method may include the step of, prior to transmitting the manufacturing sequence, providing payment instructions, and subsequently receiving payment, for the final product via the GUI.

The method may include the further step of allowing the user to share the final product specifications on social media via the GUI. The method may include the further step of allowing the user to download or print the final product specifications via the GUI.

According to a second aspect of the invention there is provided a system for product design, said system comprising:

a communications interface;

storage means; and

a processor arranged in signal communication with the communications interface and storage means, said processor adapted to:
provide a graphical user interface (GUI) whereby a user is able to input or select product specifications via the communications interface, said GUI including a plurality of design modules each providing specific product specification customisation options, the GUI further having a pricing engine configured to provide substantially real-time product pricing information according to the selected product specifications;
in response to receiving such product specifications, providing a substantially real-time user-manipulable visualisation of the specified product via the GUI;
in response to receiving a final product approbation via the GUI, automatically sequencing the product specifications required for manufacturing the final product; and
outputting such manufacturing sequence in a predetermined format.

Typically, the design modules providing specific product specification customisation options are stored on the storage means. Similarly, the pricing engine is typically stored on the storage means.

According to a third aspect of the invention there is provided a system for product design, said system having a processor adapted to perform the method steps according to the first aspect of the invention.

According to a fourth aspect of the invention there is provided a computer readable medium of instructions for product design, the computer readable medium of instructions adapted to cause a processing system, when executing such instructions, to perform the method steps according to the first aspect of the invention.

According to a fifth aspect of the invention there is provided a computer program product for use in a processing system, said computer program product comprising processor-executable instructions that, when executed, causes the processing system to perform the method steps according to the first aspect of the invention.

### BRIEF DESCRIPTION OF FIGURES

Example embodiments should become apparent from the following description, which is given by way of example only, of at least one preferred but non-limiting embodiment, described in connection with the accompanying figures.

FIG. 1 illustrates a functional block diagram of an example processing system that can be utilised to embody or give effect to a particular embodiment;

FIG. 2 illustrates an example network infrastructure that can be utilised to embody or give effect to a particular embodiment;

FIG. 3 illustrates a system diagram of one particular example of a system for product design; and

FIG. 4 illustrates a flow diagram of a method/process providing a particular example embodiment of the invention.

In the figures, incorporated to illustrate features of an example embodiment, like reference numerals are used to identify like parts throughout.

### PREFERRED EMBODIMENTS

The following modes, given by way of example only, are described in order to provide a more precise understanding of the subject matter of a preferred embodiment or embodiments to the skilled addressee. As such, some aspects of an example which are deemed readily understandable by the skilled addressee will not be described in detail, but this is not meant to detract or limit the scope of the invention in any way.

For example, reference that one example may be facilitated or performed by a programming language, such as the Java programming language, does not exclude any other suitable programming languages, nor will a comprehensive dissertation on the principles and operation of Java be provided, as such knowledge will be understood to be within the knowledge of the skilled addressee.

It is further to be appreciated that, with the following computer-implemented method and system, reference herein to “means” further expressly comprises any of the non-limiting hardware and/or software components, independently or in combination, provided for in the description below, as will be understood by the skilled addressee. In addition, such “means” may include any one or more of a computer program product for use in a local or dispersed computing system, a computer readable modulated carrier signal for interpretation by a local or dispersed computing system, or a computer readable medium of instructions for enabling a local or dispersed computing system to provide such “means” within the context of the description.

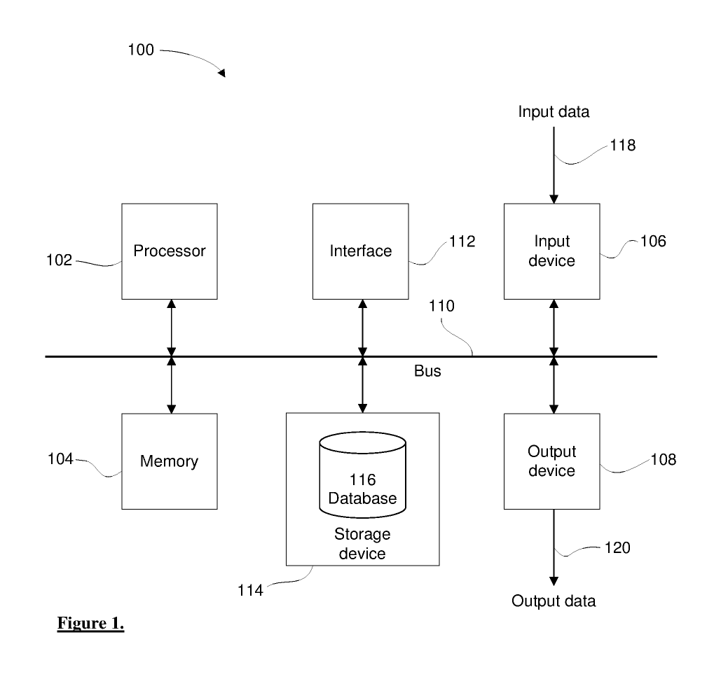

Referring firstly to FIG. 1, a particular embodiment of the present invention can be realised using a processing system, an example of which is shown in FIG. 1. In particular, the processing system 100 generally includes at least one processor 102, or processing unit or plurality of processors, memory 104, at least one input device 106 and at least one output device 108, coupled together via a bus or group of buses 110. In certain embodiments, input device 106 and output device 108 could be the same device. An interface 112 can also be provided for coupling the processing system 100 to one or more peripheral devices, for example interface 112 could be a PCI card or PC card. At least one storage device 114 which houses at least one database 116 can also be provided. The memory 104 can be any form of memory device, for example, volatile or non-volatile memory, solid state storage devices, magnetic devices, etc. The processor 102 could include more than one distinct processing device, for example to handle different functions within the processing system 100.

Input device 106 receives input data 118 and can include, for example, a keyboard, a pointer device such as a pen-like device or a mouse, audio receiving device for voice controlled activation such as a microphone, data receiver or antenna such as a modem or wireless data adaptor, data acquisition card, etc. Input data 118 could come from different sources, for example keyboard instructions in conjunction with data received via a network. Output device 108 produces or generates output data 120 and can include, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example a visual display on a monitor in conjunction with data transmitted to a network. A user could view data output, or an interpretation of the data output, on, for example, a monitor or using a printer. The storage device 114 can be any form of data or information storage means, for example, volatile or non-volatile memory, solid state storage devices, magnetic devices, etc.

In use, the processing system 100 is adapted to allow data or information to be stored in and/or retrieved from, via wired or wireless communication means, the at least one database 116. The interface 112 may allow wired and/or wireless communication between the processing unit 102 and peripheral components that may serve a specialised purpose. The processor 102 receives instructions as input data 118 via input device 106 and can display processed results or other output to a user by utilising output device 108. More than one input device 106 and/or output device 108 can be provided. It should be appreciated that the processing system 100 may be any form of terminal, server, specialised hardware, or the like.

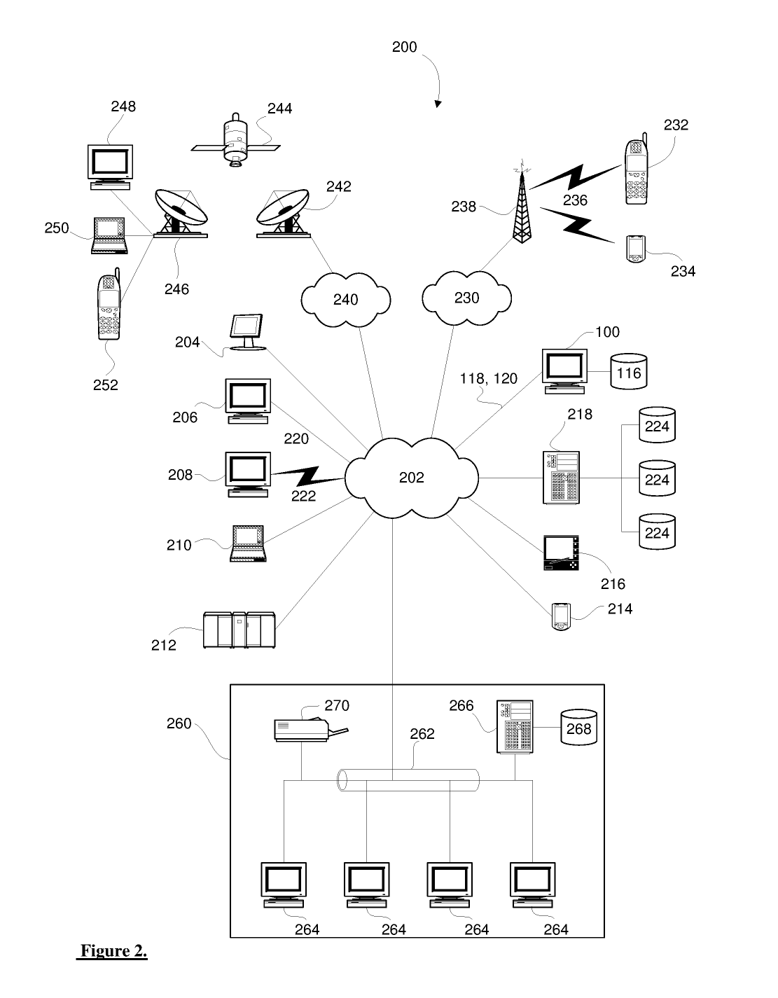

The processing system 100 may be a part of a networked communications system 200, an example of which is shown in FIG. 2. Processing system 100 could connect to network 202, for example the Internet or a WAN. Input data 118 and output data 120 could be communicated to other devices via network 202. Other terminals, for example, thin client 204, further processing systems 206 and 208, notebook computer 210, mainframe computer 212, PDA 214, pen-based computer 216, server 218, etc., can be connected to network 202. A large variety of other types of terminals or configurations could be utilised. The transfer of information and/or data over network 202 can be achieved using wired communications means 220 or wireless communications means 222. Server 218 can facilitate the transfer of data between network 202 and one or more databases 224. Server 218 and one or more databases 224 provide an example of an information source.

Other networks may communicate with network 202. For example, telecommunications network 230 could facilitate the transfer of data between network 202 and mobile or cellular telephone 232 or a PDA-type device 234, by utilising wireless communication means 236 and receiving/transmitting station 238. Satellite communications network 240 could communicate with satellite signal receiver 242 which receives data signals from satellite 244 which in turn is in remote communication with satellite signal transmitter 246. Terminals, for example further processing system 248, notebook computer 250 or satellite telephone 252, can thereby communicate with network 202. A local network 260, which for example may be a private network, LAN, etc., may also be connected to network 202. For example, network 202 could be connected with ethernet 262 which connects terminals 264, server 266 which controls the transfer of data to and/or from database 268, and printer 270. Various other types of networks could be utilised, as will be understood by the skilled addressee.

The processing system 100 is adapted to communicate with other terminals, for example further processing systems 206, 208, by sending and receiving data, 118, 120, to and from the network 202, thereby facilitating possible communication with other components of the networked communications system 200.

Thus, for example, the networks 202, 230, 240 may form part of, or be connected to, the Internet, in which case, the terminals 206, 212, 218, for example, may be web servers, Internet terminals or the like. The networks 202, 230, 240, 260 may be or form part of other communication networks, such as LAN, WAN, ethernet, token ring, FDDI ring, star, etc., networks, or mobile telephone networks, such as GSM, CDMA or 3G, etc., networks, and may be wholly or partially wired, including for example optical fibre, or wireless networks, depending on a particular implementation.

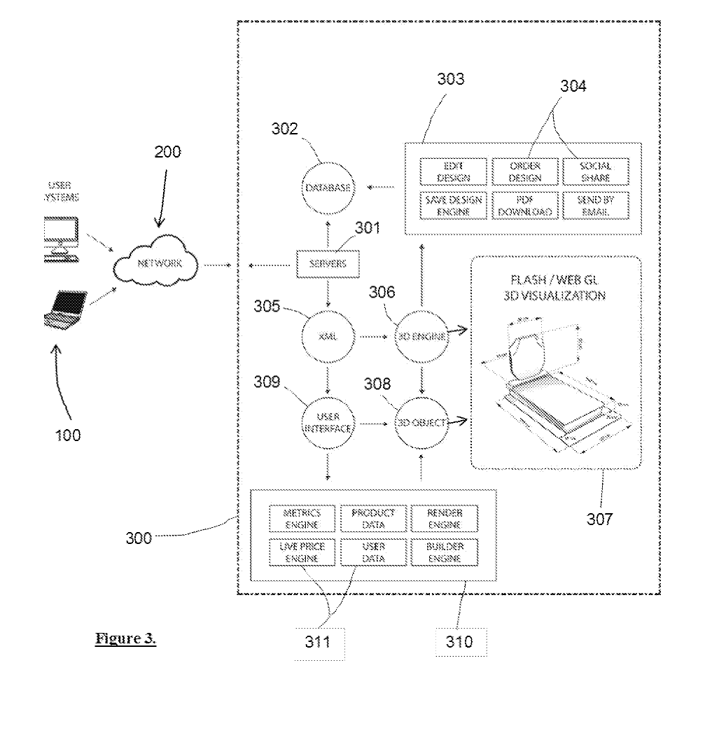

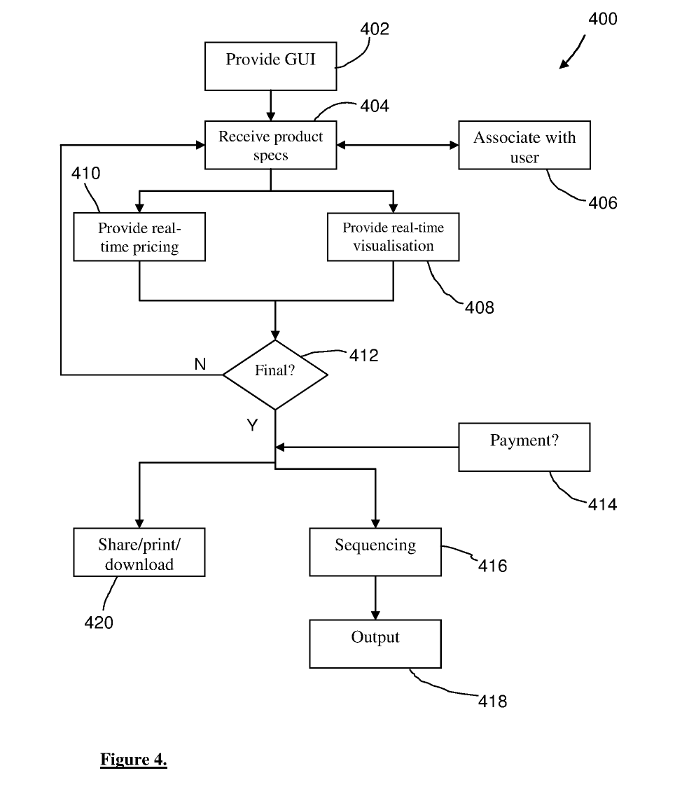

With reference now to FIG. 4 of the accompanying drawings, there is shown one example of general method steps comprising a computer-implemented method 400 for product design. Generally, these method steps are individually indicated by process blocks denoted by reference numerals 402 through 420, as described in more detail below. An example of an associated computer system 300 is shown in FIG. 3 and will be described once an example of method 400 has been given below.

The method 400 generally comprises the first step 402 of providing a graphical user interface (GUI) to a user for inputting product specifications, said GUI including a plurality of design modules each providing specific product specification customisation options.

It is to be appreciated that the method 400 is typically performed by the system 300, which is typically an example of the processing system 100, as described above. Similarly, a communications system 200 typically facilitates communication between the system 300 and the user, which is typically a terminal (such as a processing system 100) of the system 200.

Once the GUI has been provided 402, a user is able to provide product specifications, which is then received 404 by the system 300. The method 400 then provides a substantially real-time user-manipulable visualisation of the specified product via the GUI. In addition, the GUI generally further also includes a pricing engine configured to provide substantially real-time product pricing information 410 according to the selected product specifications.

This receiving 404 of product specifications with provision of real-time pricing and visualisation continues until the user has finalised the specification and customisation process, i.e. the product design has been completed to the user's requirements. Once the product has been finalised in this manner, in response to receiving a final product approbation via the GUI (indicated by block 412), the method 400 includes the step of automatically sequencing the product specifications required for manufacturing the final product. In addition, the method further includes the step 418 of outputting such manufacturing sequence in a predetermined format.

The step of providing the GUI 402 may include providing an online accessible environment or portal which, when accessed by a user, provides the GUI on a terminal of the user. For example, a webpage accessible via a web browser located on the user's terminal, or the like.

Alternatively, the step of providing the GUI 402 may include providing a set of instructions that, when executed on a terminal, provide the GUI with design modules and pricing engine. For example, a software package or application installed on a terminal of the user. Typically, in such an example, the software package or application installed on the user's terminal will include set of instructions adapted to update the GUI, design modules and/or pricing engine via a network, i.e. online updating functionality to ensure a latest version of the GUI with available design modules and pricing engine are used by the user.

It is to be appreciated that the method 400 allows for almost any type of product to be designed, as appropriate, and is thus applicable to a wide range of products. Some of these potential products may include a memorial product, an architectural product, a consumer product, an automotive product, etc. The Applicant has conceived part of the invention in the design of memorial products, and a more specific non-limiting example of the method 400 and associated system 300 will be provided in such a context below.

Accordingly, the memorial product may be selected from a non-exclusive group consisting of a headstone, a tombstone, a plaque, an urn, a monument, etc. Likewise, the architectural product may be selected from a non-exclusive group consisting of doors, windows, gates, fences, security screens, ornamentations, kitchen splashbacks, water features, garden features and ornaments, bathroom fixtures and fittings, and light fixtures and fittings, etc.

Similarly, the consumer product may be selected from a non-limiting group consisting of furniture, pet products, toys, trophies, computers, telephones, mobile phones, handbags, clothing and clothing accessories, sporting equipment, watches, footwear, jewellery and memorabilia, signage, business cards, decorative cards, etc. The automotive product may be selected from a group consisting of cars, motorcycles, boats, aeroplanes and any other forms of automotive or motive transport.

In addition to the above, as there are endless possible types of products that may find application under the present method 400 and system 300, an endless variety of product specifications exist. As such, the product specifications may be selected from a non-limiting group consisting of product type, product cost, product size, product volume, product surface area, product material, product decoration type, product decoration style, product manufacturing method, and product colour, etc. The present invention is not limited to any particular product specifications that may be selectable by the user. In this manner, the present invention typically facilitates numerous product customisation options dependent on product type.

One example may have the type of product as a food item or meal package, wherein the product specifications may include types of food items, a particular calorific content and/or amount, food items belonging to a particular food groups, and/or the like. Such an example has particular application in, for example, hospitals, nutrition programmes, healthy eating programmes, such as bodybuilding, weight loss, and the like.

Accordingly, each design module of the GUI may be configured for providing specific product specification customisation options for each of the available product specifications. Typically, a design module may comprise a database of different options for a specific product specification, e.g. where the product specification is colour, the customisation options may include blue, red, green, yellow, orange, black, white, etc.

Similarly, where the product specification includes material type for a memorial product, a particular design module may be included which provides only customisation options relating to material type, with options like granite, marble, concrete, stone, glass, etc.

The pricing engine is typically configured to provide substantially real-time product pricing information 410 by comprising a pricing algorithm adapted to calculate product pricing dependent on the selected product specification, i.e. product type, product cost, product size, product volume, product surface area, product material, product decoration type, product decoration style, product manufacturing method, and/or product colour. The pricing engine is generally configured to provide product pricing information whenever the user selects and/or changes the product specifications on the GUI.

As described earlier, it is to be appreciated that reference to ‘substantially real-time’ within this specification is to be understood as meaning an instance of time that may include a delay typically resulting from processing, calculation and/or transmission times inherent in processing systems or web-based transmissions. For example, the pricing engine is typically configured to provide pricing information whenever the product specifications change. Such changes require time to transmit from the GUI to the pricing engine, which then calculates the updated pricing information, and then transmits it back to the GUI. These transmission and calculations times, albeit of generally small duration, do introduce some delay, i.e. typically less than a minute or within milliseconds, but the user is provided with relevant feedback information relatively quickly or within ‘substantially real-time’.

As such, the pricing engine provides the user with an accurate pricing 410 for the selected product along with any selected product specification options the user has selected via the GUI. The algorithm generally uses as input the product type and selected product specifications to calculate the price the user is liable to pay once the product has been finalised.

Advantageously, the method 400 also includes the step of providing the user with the substantially real-time visualisation of the product 408, typically including all selected product specifications selected. Importantly, this visualisation is generally manipulable by the user, i.e. the user is able to view the product with selected specifications applied from various angles and in different views. Depending on requirements, this user-manipulable visualisation may include a two-dimensional and/or three-dimensional virtual rendition or representation of the product and/or product specifications with which the user is able to interact on the GUI. Such interactions may include panning, rotating or zooming the representation of the product and/or product specifications.

Once the user has finalised the product design and customisation, the method 400 includes the step of receiving final product approbation or approval 412, which generally comprises receiving an indication from the user that no more product specifications will be selected and/or customised. In addition, in the current example, the method 400 also includes a step of associating the final product specifications, i.e. final designed and customised product, with the user 406. Such a step of associating 406 typically includes registering a user profile on a database and linking the final product specification with such user profile, as is well understood in the art of online retail.

In addition, the method 400 also typically includes the step of, prior to finalising and transmitting the manufacturing sequence 416, providing payment instructions, and subsequently receiving payment, for the final product via the GUI 414. This feature is also well understood in the art of online retail and will not be described in any detail.

As such, once the product design has been finalised 412, associated with the user 406 and paid for 414, the method generally includes the step of automatically sequencing the product specifications 416, which typically includes determining an order in which the selected product specifications are to be manufactured and/or applied to the product. It is to be understood that such sequencing is generally product- and product specification-dependent, i.e. the manufacturing and customisation sequence for a product will depend on the specified options etc. It is thus also to be appreciated that the step of sequencing involves a manner of ‘intelligent’ decision-making or discernment by a computer system performing the method, as the manufacturing of a product depends on the selected product specifications, the type of product, availability of manufacturing capacity, etc.

For example, where the product is a memorial headstone with specified options of a specific material, a particular shape, laser etching, gold trimming and sandblasted image thereon, a first step in the sequence may comprise ordering the material from a supplier, the second step being for a stonemason to shape the ordered material, a third step being applying the sandblasted image, a fourth step the gold trim, with a final step being the laser etching.

The sequencing steps may be dependent on each other, i.e. one step cannot be completed before the preceding step has been finalised. Alternatively, and importantly, the sequencing may also include tasks to be completed in parallel, product dependent.

As such, the step of outputting 418 the manufacturing sequence generally includes providing an indication of the selected product specifications and the order in which they are to be manufactured and/or applied to the product. The step of outputting the manufacturing sequence 418 typically includes transmitting this sequence to at least one manufacturing facility.

The step of outputting 418 is typically done in a predetermined format, generally a manufacturing machine-interpretable format, such as a vector file format, an Encapsulated PostScript (EPS) file format, a graphical file format (JPG, JPEG, BMP, GIF, etc.), or the like. In this manner, the output can be fed directly into the relevant manufacturing machine, as required. For example, if the product includes laser etching as a product specification, the output may include an EPS file which can be inputted directly into a laser etching machine, or the like.

Advantageously, in one example, the method 400 also includes the further step of allowing the user to share the final product specifications 420 on social media via the GUI. Similarly, the method 400 generally includes the further step of allowing the user to download or print 420 the final product specifications via the GUI.

As described above, with reference now to FIG. 3 of the accompanying drawings, the present invention further provides for an associated system 300 for product design. The system 300 is generally used to perform the relevant method steps 400, described above.

In the current example, the system 300 generally interfaces with the user by means of a communications interface in the form of a networked server 301, as shown. As described above, the user generally makes use of some type of terminal comprising the processing system 100 and interfaces with the system 300 by means of an example of the communications system 200.

The system 300 also includes a storage means 302 and a processor 310 arranged in signal communication with the communications interface 301 and the storage means 302, as shown. The storage means or database 302 generally stores particular machine code that operatively embodies a set of instructions whereby the processor 310, when executing these instructions, is adapted to provide a graphical user interface (GUI) 309 whereby a user is able to input the product specifications via the communications interface. Preferably, this is done via the user accessing the GUI as a webpage hosted on the Internet, or the like.

As described above, the GUI includes a plurality of design modules 311 each providing specific product specification customisation options, including the pricing engine configured to provide substantially real-time product pricing information according to the selected product specifications. In the current example, the processor 310 is executing instructions associated with some of the design modules 311, as shown. However, the system 300 includes other design modules 304 allocated in memory 303 as part of storage means 302 that is not currently being executed in the exemplified embodiment, but may be executed by processor 310 at a later stage of the method steps 400, described earlier.

In the current example, the GUI 309 is based on the Extensible Mark-up Language 305 (XML), using Scalable Vector Graphics (SVG) which is an XML-based vector image format for two-dimensional graphics with support for interactivity and animation. The SVG specification is an open standard developed by the World Wide Web Consortium (W3C). SVG images and their behaviours are defined in XML text files, making them able to be searched, indexed, scripted, and compressed. Advantageously, all major modern web browsers—including Mozilla Firefox®, Internet Explorer®, Google® Chrome®, Opera®, and Safari®—support this format or have at least some degree of SVG rendering support.

As a result, in one example, the system 300 allows users to create SVG documents with use of an XML interface to control elements like slider bars, input boxes and check boxes to select products and/or product specifications. These files or documents can be saved on a web server or storage means 302 and then edited again to apply any change in the saved design prior to sending it to the manufacturer.

In this example, the system 300 uses a Java Script framework and library for mobile and touch events support. With use of these libraries, the GUI 309 is able to match any device screen size and make a maximum use of screen real estate. Typically, the system 300 obtains Java Scripts from a web server with use of a server-side language (PHP), which also provides information about user localization, which allows the system 300 to automatically set interface's language, metric and currency used during the program run time.

These settings can also be changed manually (metric, currency) during the design steps. The same mechanism is used for saving the design and sending them to the web server as a JSON object for inserting it to the database (MySQL) as well as storing them as SVG files on a server. The system 300 also finds particular application on mobile phone handsets where it loads from a web server predefined SVG shapes as a container for a design and allows users to put their additional SVG files with clipart as a part of the design. Users also have an opportunity to upload their own images to the web server and use these images as photos with a choice of predefined mask styles (oval, rectangle, heart, tear, star).

These uploaded images are saved onto a web server or similar storage means 302 and inserted as a Base64 encoded strings into the SVG design, making the output SVG saved design file complementary for later use it with external software like Adobe® Illustrator®. The system 300 typically uses SVG paths, text, clipping, masking and compositing, filter effects, interactivity, scripting, fonts and animation to allow user easily design its own product on any device and send it to family and friends.

In addition (and as described with reference to the method 400 above), the system 300, in response to receiving product specifications from a user via the GUI 309, provides a substantially real-time user-manipulable visualisation 307 of the specified product by means of the GUI. In order to achieve this, the processor 310 typically executes instructions for a 3D engine 306 in order to render the product with specifications as a 3D object 308, as shown.

As described with reference to the method 400 above, in response to receiving a final product approbation or approval from the user via the GUI 309, the system 300 automatically sequences the product specifications required for manufacturing the final product, and outputs this manufacturing sequence in a predetermined format.

The scope of the present invention further encompasses a computer readable medium of instructions for product design, the computer readable medium of instructions adapted to cause a processing system 100, when executing such instructions, to perform the method steps 400.

Similarly, the scope of the present invention extends to a computer program product for use in a processing system 100, said computer program product comprising processor-executable instructions that, when executed, causes the processing system to perform the method steps 400.

### Further Example

The following example provides a more detailed discussion of a particular embodiment of the method 400. The example is intended to be merely illustrative and not limiting to the scope of the present invention.

Thus, there has been provided a computer-implemented method 400 and associated system 300 for product design. The following examples are provided where the product is a memorial product, as described above.

In an example of a design for a custom memorial product which is represented via the GUI 209, the following steps are performed:

1. opening a webpage which becomes the GUI 309 and accessing the network server or storage means 302. This access to the system 300 is generally on a high-level of accessibility and usability across a range of common devices and web browsers.

2. entering into the Extensible Mark-up Language-based (XML) format the product specifications and customisations options. The GUI allows for the user to access multiple product options and auxiliary information on the product range, process and company manifesto.

3. choosing a specific product for design. This process typically involves selecting a product from the home page which takes the user to a design your own button for the product of choice.

4. entering into the GUI the design specifications. These include but are not limited to the following design stages achievable by clicking on their respective buttons in the user interface:
a. ‘Select shape’—selecting a shape in the product range which is chosen by the user by clicking on the visual of the desired product shape.
b. ‘Select Width and Height’—the user may change the dimensions of the desired product. This is achieved by using a slider bar (as well as typing in a value in the measurement display) that controls measurements in millimetres and of which the maximum and minimum measurements match with the tangible product counterpart.
c. ‘Add an inscription’—in this step, the user interface will display an empty text box where the user may insert characters to form one line of text. The text instantly appears on the displayed product visualisation and the font is also able to be changed by clicking on the font name which is situated below the box. The ability to add a new individual line, duplicate and delete a line of text is achievable by clicking on the appeared text displayed on the product visualization. The rotation of the text is also linked to a slider bar with an optional numerical input. The positioning of the text is controlled by the user clicking on the line of text and holding the selection whilst moving the cursor around to situate the text in the desired position. The cursor becomes a pointing hand to demonstrate the graphic is fluid.
d. ‘Add a graphic (motif) from the online database libraries’—database libraries containing Scalable Vector Graphics, image files and fonts are accessible by the user. Depending on the material designed onto, these decorative motifs may be an addition of a single or multiple stainless steel motif, 1 or 2 coloured raised motif (stainless steel and coloured glass which have limited motifs in each library), laser granite etching (of which there are 5000+ to choose from).
e. ‘Add personal image’—personal photos and picture files can be uploaded by the user. The user has the option of selecting a method of adding the image to the product, and the product base material this will depend on the options of how the image can be presented. For example, for the black granite products, the user may choose to add their photo or image by method of laser engraving directly onto the product (Granite Image) or have another piece of granite printed, cut to shape and fixed onto the face of the product. These options only produce greyscale graphics. Other stick on options that use colour printing methods may be a ceramic, porcelain (both of which are similar, however come in different shapes and sizes) or even vitreous enamel or milled aluminium alloy (Lifetime image overlay) stick on addition that a graphic is printed and baked onto.
f. ‘Add bases/auxiliary elements’—some products require another piece for the user to choose. Any product that needs a display base or another element for construction will have an option for the user to choose from.
g. ‘Check price’—at any stage, the user is able to check the price of their current design. This real-time pricing engine or live price checking algorithm on the system 300 gives the user opportunity to check their design fits within their budget before saving a design and moving forward with their purchase.
h. ‘Save design’—at the end of the design process, the user may click on the “Save Your Design” button which brings up a text box to insert a name for the design for future reference.

5. Registering the user's details. After entering a name for their design the user is taken to a page where they are asked for their registration details, or to log into a previously registered account. This account is linked to the users submitted email account and they are able to access all their saved designs at any stage. As the user has registered their details, they are able to access all their designs and edit at any stage. During the design process, the platform allows the user to easily go back and make changes to their design as well as allow the user to save design at any stage. Editing any design will have the option to save it as a new design, keeping the original intact. The user is able to click on the Print button option and personally save or print a copy of their design. Alternatively, the user has the option to email their design graphic to their and others email address for a digital copy of the graphic and detailed quote for their reference. The user has the option of sharing their graphic on social media.

6. buy or purchase of product. The user may fully purchase the product after the design is submitted. This function is limited to digital funds transfers; however the user may also wish to pay a cash deposit in person.

7. the users design is sent directly to the website server. When a user successfully saves a design, this is emailed directly to an email account of the system 300. All designs are also accessible via the webpage, where the full details of the design made is outlined and copies of all the uploaded images are accessible.

8. server database collection. All information detailed along with the user's design output files provides the necessary fundamentals to transpose the design onto the physical product using the appropriate methods in factories/workshops.

9. shipping. The final product is then shipped to the user or directly to the cemetery for instillation.

The Applicant believes it advantageous that the present method 400 and system 300 provides for an easy to use, internet based, design system for personalising the design of memorial products using the 2D and 3D data visualization based on user selections and inputs. The system 300 also includes design modules and algorithms that work together to enable the data to be manually entered or uploaded as files, then displayed or visualised through a graphic user interface (GUI) with a high level of accessibility and usability.

The Applicant believes the present invention is able to provide a user with freedom and flexibility in the products that can be designed. A user is able to easily select their desired product to begin the design process. They then may add data (text, photos and artwork) and manipulate all added data by changing the size and location of it which appears as a visualisation and conceptualisation of the design as it developed on the product via the GUI. The user is able to obtain a price of their customized product at any stage of the design process and receives a detailed quote at the end of the design process.

Advantageously, the system 300 collects all design information and raw data, making it available on the system, whilst also potentially notifying the system 300 during the design phase so that communication with the user is facilitated. The system 300 can notify when the user submits an order with the completed design to ensure swift execution. Because there is a strong correlation with the design software and subsequent engineering processes, this facilitates a rapid translation of the user design which is accurately reproduced onto the end product, fitting within the parameters (size and shape), specifications and tolerances of the physical product.

With particular application in the memorial product space, by providing an open access online product design system, it is possible to simplify online shopping for users, while simultaneously allowing access to a memorial product range for those who have lost animals and wish to memorialise them the same way in which we traditionally honour family members.

The Applicant further believes it advantageous that the design system and method described herein can be a portal for a user straight to a manufacturer of whatever product is desired. The invention can serve as a communication medium where language is a barrier, for example where products are manufactured in China, the manufacturing sequence in a predetermined format is enough to enable such manufacturing without requiring a need for description in any particular language.

The system enables a portal that allows a customer to directly trade with the manufacturers which can save substantial costs, as no agent to middleman is required. Similarly, as order volumes for certain products increase, the method and system can facilitate overseas manufacturers to bid for the work online, etc.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although a preferred embodiment has been described in detail, it should be understood that various changes, substitutions, and alterations can be made by one of ordinary skill in the art without departing from the scope of the present invention.

The present invention may take the form of an entirely hardware embodiment, an entirely software embodiment, firmware, or an embodiment combining software and hardware aspects.

It should be appreciated that the scope of the invention is not limited to the scope of the embodiment described. Various modifications and improvements may be made to the embodiment described without departing from the scope of the invention.

Throughout this specification, unless the context requires otherwise, the word “comprise” or variations such as “comprises” or “comprising”, will be understood to imply the inclusion of a stated integer or group of integers but not the exclusion of any other integer or group of integers.

It is to be appreciated that reference to “one example” or “an example” of the invention is not made in an exclusive sense. Accordingly, one example may exemplify certain aspects of the invention, whilst other aspects are exemplified in a different example. These examples are intended to assist the skilled person in performing the invention and are not intended to limit the overall scope of the invention in any way unless the context clearly indicates otherwise.

1-32. (canceled)

33. A computer-implemented method for product design, said method comprising the steps of:
providing a graphical user interface (GUI) to a user for inputting or selecting product specifications, said GUI including a plurality of design modules each providing specific product specification customisation options, each design module comprising a database of different options for a specific product specification selectable from a group consisting of product type, product cost, product size, product volume, product surface area, product material, product decoration type, product decoration style, product manufacturing method, and product colour, with each design module configured to provide specific product specification customisation options for each of the available product specifications;
said GUI further having a pricing engine comprising a pricing algorithm adapted to provide substantially real-time product pricing information according to any of the selected product specifications whenever the user selects and/or changes the product specifications;
in response to receiving such product specifications, providing a substantially real-time user-manipulable visualisation of the specified product via the GUI;
in response to receiving a final product approbation via the GUI, automatically sequencing the product specifications required for manufacturing the final product; and
outputting such manufacturing sequence in a predetermined format.

34. The method of claim 33, wherein the step of providing the GUI includes providing an online accessible environment or portal which, when accessed by a user, provides the GUI on a terminal of the user.

35. The method of claim 33, wherein the step of providing the GUI includes providing a set of instructions that, when executed on a terminal, provides the GUI with design modules and pricing engine, said set of instructions adapted to update the GUI, design modules and/or pricing engine via a network.

36. The method of claim 33, wherein the product is selected from a group consisting of a memorial product, an architectural product, a consumer product and an automotive product.

37. The method of claim 36, wherein the memorial product is selected from a group consisting of a headstone, a tombstone, a plaque, an urn and a monument.

38. The method of claim 36, wherein the architectural product is selected from a group consisting of doors, windows, gates, fences, security screens, ornamentations, kitchen splashbacks, water features, garden features and ornaments, bathroom fixtures and fittings, and light fixtures and fittings.

39. The method of claim 36, wherein the consumer product is selected from a group consisting of furniture, pet products, toys, trophies, computers, telephones, mobile phones, handbags, clothing and clothing accessories, sporting equipment, watches, footwear, jewellery and memorabilia, signage, business cards, food items, meals having a specific calorific content and make-up, and decorative cards.

40. The method of claim 33, wherein the user-manipulable visualisation includes a two-dimensional and/or three-dimensional virtual rendition or representation of the product and/or product specifications with which the user is able to interact on the GUI, said interactions including panning, rotating or zooming the representation of the product and/or product specifications.

41. The method of claim 33, wherein the step of receiving final product approbation includes receiving an indication from the user that no more product specifications will be selected and/or customised.

42. The method of claim 33, wherein the step of automatically sequencing the product specifications include determining an order in which the selected product specifications are to be manufactured and/or applied to the product.

43. The method of claim 33, wherein the step of outputting the manufacturing sequence includes providing an indication of the selected product specifications and the order in which they are to be manufactured and/or applied to the product.

44. The method of claim 33, wherein the predetermined format includes a manufacturing machine-interpretable format, such as a vector file format, an Encapsulated PostScript (EPS) file format, a graphical file format (JPG, JPEG, BMP, GIF), or the like.

45. The method of claim 33, which includes a step of associating the final product specifications with the user, the step of associating including registering a user profile on a database and linking the final product specification with such user profile.

46. The method of claim 33, which includes the step of transmitting the manufacturing sequence to at least one manufacturing facility.

47. The method of claim 46, which includes the step of, prior to transmitting the manufacturing sequence, providing payment instructions, and subsequently receiving payment, for the final product via the GUI.

48. The method of claim 33, which includes the further step of allowing the user to share the final product specifications on social media via the GUI.

49. A system for product design, said system comprising:
a communications interface;
storage means; and
a processor arranged in signal communication with the communications interface and storage means, said processor adapted to:
provide a graphical user interface (GUI) whereby a user is able to input or select product specifications via the communications interface, said GUI including a plurality of design modules each providing specific product specification customisation options, each design module comprising a database of different options for a specific product specification selectable from a group consisting of product type, product cost, product size, product volume, product surface area, product material, product decoration type, product decoration style, product manufacturing method, and product colour, with each design module configured to provide specific product specification customisation options for each of the available product specifications, the GUI further having a pricing engine comprising a pricing algorithm adapted to provide substantially real-time product pricing information according to the selected product specifications whenever the user selects and/or changes the product specifications;
in response to receiving such product specifications, providing a substantially real-time user-manipulable visualisation of the specified product via the GUI;
in response to receiving a final product approbation via the GUI, automatically sequencing the product specifications required for manufacturing the final product; and
outputting such manufacturing sequence in a predetermined format.

50. The system of claim 49, wherein the design modules providing specific product specification customisation options are stored on the storage means for operative execution by the processor.

51. The system of claim 49, wherein the pricing engine is stored on the storage means for operative execution by the processor.

52. A computer program product for use in a processing system, said computer program product comprising processor-executable instructions that, when executed, causes the processing system to perform the method steps according to claim 1.
